(19) United States
(12) Patent Application Publication
(10) Pub. No.: US 2020/0108649 A1
(43) Pub. Date: Apr. 9, 2020

(54) READING APPARATUS, PRINTER, AND INFORMATION PROCESSING METHOD

(71) Applicant: TOSHIBA TEC KABUSHIKI KAISHA, Tokyo (JP)

(72) Inventor: Ken Masuda, Mishima Shizuoka (JP)

(21) Appl. No.: 16/154,799

(22) Filed: Oct. 9, 2018

(51) Int. Cl. B41J 29/38; G06K 9/18; G06K 9/03; G06K 9/00

(52) U.S. Cl. CPC B41J 29/38; G06K 9/186; G06K 2209/01; G06K 9/00496; G06K 9/03

(57) ABSTRACT

According to one embodiment, a reading apparatus includes: a magnetic head, a moving mechanism, a recognition unit, a control unit, and a setting unit. The moving mechanism moves at least one of the magnetic head and a print medium facing the magnetic head and on which a character is printed by using a magnetic ink such that a facing position of the magnetic head with respect to the print medium is changed. The recognition unit recognizes the character based on a read signal output by the magnetic head according to a change in the magnetic field by the magnetic ink. The control unit controls the moving mechanism and the recognition unit such that, when the recognition unit fails to recognize the character, recognition is performed after a speed of change of the facing position is changed. The setting unit sets a speed of change for initial recognition with respect to one print medium, according to a speed of change of when the recognition unit succeeds in recognition with respect to another print medium.

### FIELD

Embodiments described herein relate generally to a reading apparatus, a printer, and an information processing method.

### BACKGROUND

A reading apparatus that reads characters printed on a print medium, such as a check, by using magnetic ink already exists. Such a reading apparatus includes a magnetic head. The magnetic head outputs a read signal according to a change in a magnetic field when a facing position with the print medium is changed. Also, the reading apparatus recognizes the characters printed on the print medium by comparing a waveform of the read signal and a known waveform of each character.

In this regard, it is required to improve probability of successful recognition.

In addition, an example of technology for improving probability of successful recognition includes JP-A-11-259802.

### DESCRIPTION OF THE DRAWINGS

FIG. 1 is a block diagram illustrating a configuration of a main circuit of a printer according to an embodiment;

FIG. 2 is a flowchart illustrating a procedure of information processing of a processor illustrated in FIG. 1, in relation to reading and printing of a bill;

FIG. 3 is a flowchart illustrating the procedure;

FIG. 4 is a diagram illustrating an example of a waveform of a read signal;

FIG. 5 is a diagram illustrating another example of the waveform;

FIG. 6 is a flowchart illustrating a processing procedure of the processor in relation to speed setting illustrated in FIG. 2; and

FIG. 7 is a flowchart illustrating the processing procedure.

### DETAILED DESCRIPTION

A waveform of a read signal can change according to a usage environment, such as a temperature or humidity, a magnetization state of the magnetic ink, or a speed of change of a facing position of the magnetic head. Due to such a change in the waveform, it may be difficult to recognize the characters correctly. Various embodiments are described that recognize the characters correctly from the waveform of a read signal despite changes/variances in a usage environment.

Hereinafter, one example of an embodiment will be described with reference to the drawings. In the embodiment, a printer having a function as a reading apparatus will be described as an example. Also, in the embodiment, a print medium on which a character has been printed by using a magnetic ink may be a bill, such as a check or a promissory note.

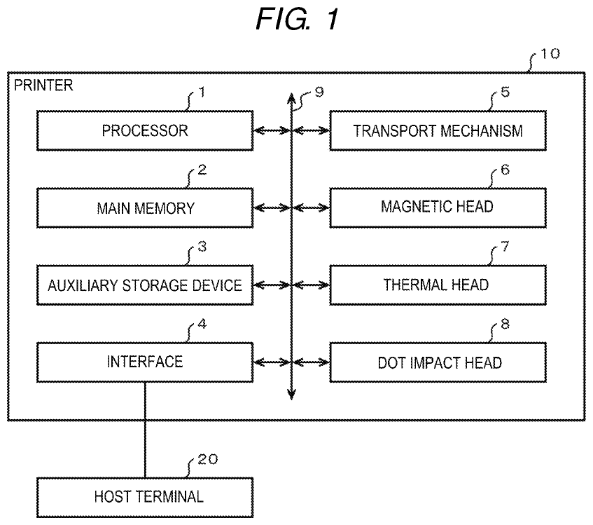

FIG. 1 is a block diagram of a configuration of a main circuit of a printer 10 according to the embodiment.

The printer 10 reads a character printed on a bill by using magnetic ink, and transmits read data indicating a result of reading the character to a host terminal 20. Also, the printer 10 prints arbitrary information regarding the bill, based on a command from the host terminal 20.

The host terminal 20 is a host computer or a point-of-sale (POS) terminal. The host terminal 20 performs well-known information processing related to using and managing of the bill.

The printer 10 includes a processor 1, a main memory 2, an auxiliary storage device 3, an interface 4, a transport mechanism 5, a magnetic head 6, a thermal head 7, a dot impact head 8, and a transmission path 9. The processor 1, the main memory 2, the auxiliary storage device 3, the interface 4, the transport mechanism 5, the magnetic head 6, the thermal head 7, and the dot impact head 8 are connected to each other via the transmission path 9. The processor 1, the main memory 2, and the auxiliary storage device 3 are connected to each other via the transmission path 9 to constitute a computer performing information processing for controlling the printer 10.

The processor 1 corresponds to a central portion of the computer. The processor 1 performs information processing according to information processing programs of an operating system, middleware, and an application program so as to control each component of the printer 10 to perform various functions.

The main memory 2 corresponds to a main storage portion of the computer. The main memory 2 includes a non-volatile memory region and a volatile memory region. The main memory stores the information processing programs in the non-volatile memory region. Also, the main memory 2 may store data required for the processor 1 to control each component, in the non-volatile or volatile memory region. The main memory 2 uses the volatile memory region as a work area where the processor 1 may appropriately rewrite data.

The auxiliary storage device 3 corresponds to an auxiliary storage portion of the computer. The auxiliary storage device 3 may use, for example, an electric erasable programmable read-only memory (EEPROM), a hard disc drive (HDD), a solid state drive (SSD), or any type of well-known storage device. The auxiliary storage device 3 stores data used by the processor 1 to perform various processes and data generated via processes of the processor 1. The auxiliary storage device 3 may store the information processing programs.

The host terminal 20 is connected to the interface 4. The interface 4 performs processes for transmitting or receiving data to or from the host terminal 20. As the interface 4, an existing component conforming to the well-known standard, such as a universal serial bus (USB), may be used. Also, the interface 4 may transmit or receive data via radio communication conforming to the wireless local area network (LAN) standard.

The transport mechanism 5 transports the bill inserted as a reading and printing target from an insertion hole into the printer 10 along a pre-set acquisition path. The transport mechanism 5 transports the bill of acquisition completion to a discharge hole along a pre-set discharge path. Here, the insertion hole and the discharge hole may be the same or may be different from each other. The transporting of the bill by the transport mechanism 5 corresponds to moving of at least one of the bill and the magnetic head 6 so as to change a facing position of the magnetic head 6 with respect to the bill. In other words, the transport mechanism 5 is an example of a moving mechanism for such movement.

The magnetic head 6 is provided facing the acquisition path, and faces the bill transported by the transport mechanism. The magnetic head 6 outputs, as a read signal, an electric signal having a voltage level fluctuating according to a change in a magnetic field caused when the character printed on the bill by using the magnetic ink is passed. In addition, a magnet for magnetizing the magnetic ink is provided at an upper region of the acquisition path with respect to the magnetic head 6.

The thermal head 7 is provided facing the discharge path and performs printing on the bill transported by the transport mechanism 5, via a thermal transfer method.

The dot impact head 8 is provided facing the discharge path and performs printing on the bill transported by the transport mechanism 5, via a dot impact method.

The transmission path 9 includes an address bus, a data bus, a control signal line, and the like to transmit data or control signal transmitted or received between components connected to each other.

Operations of the printer 10 configured as above will now be described.

When a condition for starting processing of the bill is satisfied, the processor 1 starts information processing described below, based on the information processing programs stored in the main memory 2 or the auxiliary storage device 3. Here, the condition is arbitrarily determined by a designer of the printer 10, a preparer of the information processing programs, or the like. The condition may be, for example, an input of a read start command output from the host terminal 20 through the interface 4. Another example of the condition may be, when the printer 10 may include a sensor, detection by the sensor that the bill has been inserted into the insertion hole.

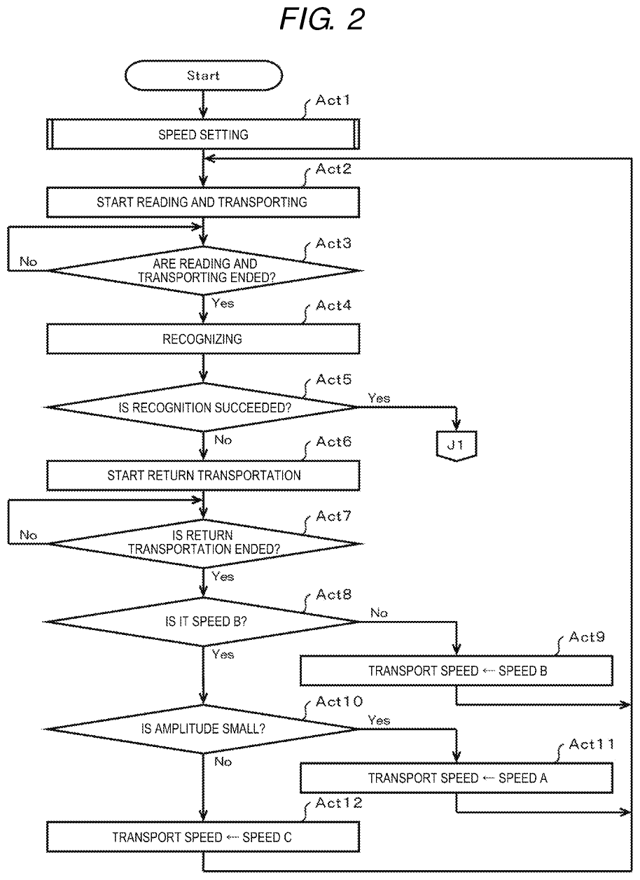

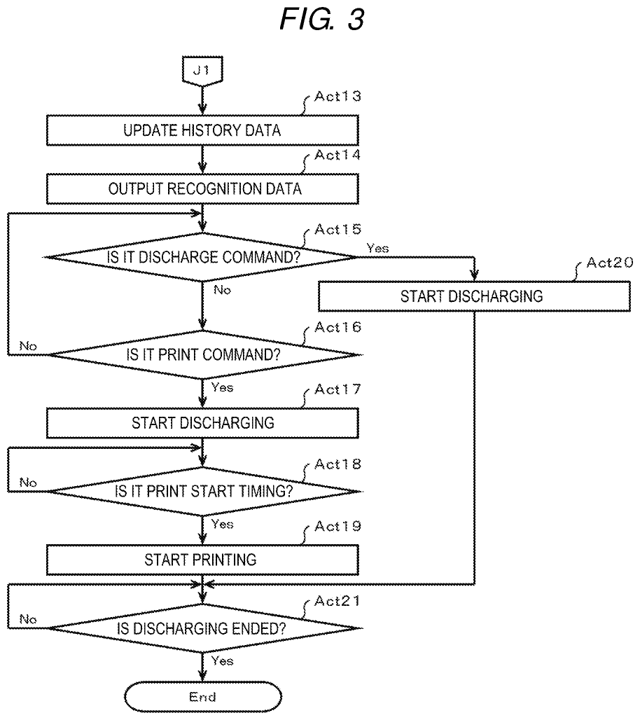

FIGS. 2 and 3 are flowcharts of a procedure of information processing of the processor 1, in relation to reading and printing of a bill. Here, it will be understood that operations described below are only an example, and thus an order of some operations may be changed, some operations may be omitted, or another operation may be added.

In FIG. 2, the processor 1 performs speed setting, in Act 1. The speed setting is a process of setting an initial transport speed of the transport mechanism 5 transporting the bill. Details about the speed setting will be described later. Also, in the current embodiment, there are three types of transport speeds of the bill by the transport mechanism 5, which are in the relationship of Speed A>Speed B>Speed C. Accordingly, the processor 1 sets, via the speed setting, any one of Speed A, Speed B, and Speed C as the initial transport speed. Alternatively, there may be two or at least four types of transport speeds.

In Act 2, the processor 1 causes the transport mechanism to start reading and transporting. The reading and transporting is a process in which the bill inserted from the insertion hole is transported in a direction to be introduced into the printer 10 (hereinafter, referred to as a forward direction) along the acquisition path. The transport mechanism 5 transports the bill in the forward direction at the speed set in Act 1, according to the start control of the processor 1. When the bill is transported to a pre-set position, the transport mechanism 5 ends the reading and transporting. The transport mechanism 5 may include a sensor that is turned on when the bill reaches the pre-set position, and end the reading and transporting when the sensor is turned on. Alternatively, the transport mechanism 5 may end the reading and transporting when a time elapsed after the reading and transporting is started is equal to a time required to transport the bill from the insertion hole to the pre-set position. Here, the ending of the reading and transporting may be controlled via the information processing of the processor 1.

While the bill is transported by the reading and transporting, a region of the bill, which is printed by using the magnetic ink, passes through a reading position of the magnetic head 6. At this time, the magnetic head 6 changes an output voltage according to a change in a magnetic field around the magnetic head 6. Accordingly, the magnetic head 6 outputs, as a read signal, an electric signal in which a voltage level fluctuates based on the character printed by using the magnetic ink. The magnetic head 6 includes a buffer therein, and samples the read signal at a pre-set sampling period and stores a sampling value during the reading and transporting in the buffer. Alternatively, when the magnetic head 6 does not include a buffer, the processor 1 or a controller of the magnetic head 6 may store the sampling value in the main memory 2 or the auxiliary storage device 3.

In Act 3, the processor 1 stands by until the reading and transporting is ended. When the transport mechanism 5 ended the reading and transporting, the processor 1 determines ‘Yes’, and performs Act 4.

In Act 4, the processor 1 performs recognizing. The recognizing is a process in which the character printed by using the magnetic ink is determined by determining whether a waveform of the read signal will match a known waveform of the character, by using the sampling value obtained as described above as a process target. Since a well-known process may be used as the recognizing, details thereof will not be provided herein. The computer including the processor 1 as a central portion may operate as a recognition unit when the processor 1 performs the information processing based on the information processing programs.

In Act 5, the processor 1 determines whether recognition according to the recognizing succeeded. When the character is not recognized without an error, the processor 1 determines ‘No’ and performs Act 6.

In Act 6, the processor 1 causes the transport mechanism 5 to start return transportation. The return transportation is transportation of the bill to the insertion hole in a direction opposite to the forward direction (hereinafter, referred to as a reverse direction) along the acquisition path. The transport mechanism 5 transports the bill in the reverse direction according to a command from the processor 1. The transport mechanism 5 ends the return transportation when the bill is transported to a pre-set return position. The return position is a position where an entire region where a character string may be printed by using the magnetic ink is positioned closer to the insertion hole than the reading position by the magnetic head 6, and for example, may be determined by a designer of the printer 10.

In Act 7, the processor 1 stands by until the return transportation is ended. When the transport mechanism 5 ended the return transportation, the processor 1 determines ‘Yes’ and performs Act 8.

In Act 8, the processor 1 determines whether the speed set for the previous reading and transporting is speed B. When the speed set for the previous reading and transporting was Speed A or Speed C, the processor 1 determines ‘No’ and performs Act 9.

In Act 9, the processor 1 sets Speed B as the transport speed for next reading and transporting. Then, the processor 1 performs Act 2 and subsequent operations in the same manner as described above. In other words, the processor 1 attempts to recognize a character by performing reading and transporting at a transport speed different from that in the previous reading and transporting by one step.

Meanwhile, when the recognition failed but the transport speed was Speed B, the processor 1 determines ‘Yes’ in Act 8 and performs Act 10.

In Act 10, the processor 1 determines whether amplitude of the read signal is small.

Here, the read signal output by the magnetic head 6 maintains an almost constant voltage value (hereinafter, referred to as a standard value) when a magnetic field does not change. Also, a voltage of the read signal increases or decreases based on the standard value when the magnetic field changes.

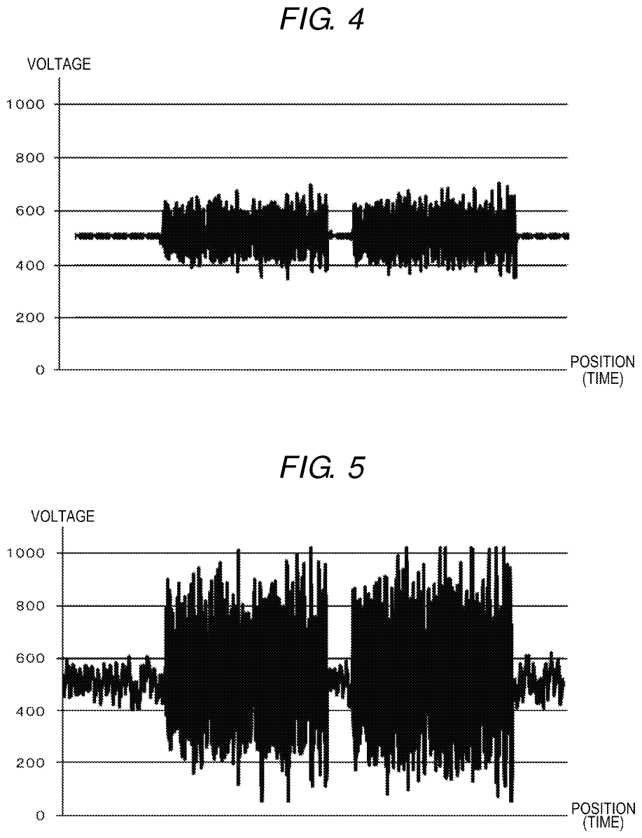

FIGS. 4 and 5 are diagrams of examples of a waveform of the read signal.

In FIGS. 4 and 5, the amplitudes of the read signal are different from each other, wherein the amplitude of FIG. 5 is larger than the amplitude of FIG. 4. The difference in the amplitudes of the read signal is mainly caused by the transport speed of the bill. When the transport speed is high, the amplitude of the read signal is large. Also, the amplitude of the read signal may change according to an usage environment, such as a temperature or humidity, a magnetization state of the magnetic ink, or the like.

As illustrated in FIG. 4, when the amplitude is small, the difference in waveforms of characters is small, and thus recognition accuracy of the character may decrease. Meanwhile, as illustrated in FIG. 5, when the amplitude is large, the waveform is distorted and a noise component is increased, and thus recognition accuracy of the character may decrease.

When the amplitude is small as illustrated in FIG. 4, the amplitude may be enlarged by increasing the transport speed. Meanwhile, when the amplitude is large as illustrated in FIG. 5, the amplitude may be reduced by decreasing the transport speed.

Here, for example, the processor 1 determines that the amplitude is small when a highest peak value of the read signal is lower than a pre-set first threshold value or when a smallest peak value of the read signal is equal to or higher than a pre-set second threshold value smaller than the first threshold value. When it is determined that the amplitude is small as such, the processor 1 determines ‘Yes’ in Act 10, and performs Act 11. Alternatively, the processor 1 may obtain an average value of peaks and an average value of troughs respectively as a first average value and a second average value, and compare the first average value and the second average value respectively with a first threshold value and a second threshold value.

In Act 11, the processor 1 sets Speed A as the transport speed for the next reading and transporting. Then, the processor 1 performs Act 2 and subsequent operations in the same manner as described above. Here, the transport mechanism 5 transports the bill at Speed A set in Act 11. In other words, the processor 1 attempts to recognize a character by performing the reading and transporting at a transport speed faster than that in the previous reading and transporting.

When it is determined that the amplitude is not small, the processor 1 determines ‘No’ in Act 10, and performs Act 12.

In Act 12, the processor 1 sets Speed C as the transport speed for the next reading and transporting. Then, the processor 1 performs Act 2 and subsequent operations in the same manner as described above. Here, the transport mechanism 5 transports the bill at Speed C set in Act 12. In other words, the processor 1 attempts to recognize a character by performing the reading and transporting at a transport speed slower than that in the previous reading and transporting.

As described above, when the character is failed to be recognized via one reading, the processor 1 changes the transport speed of the bill, and controls the bill to be read again. As such, the computer including the processor 1 as the central portion operates as a control unit performing the above control when the processor 1 performs the information processing based on the information processing programs.

Meanwhile, when the standard value is about 500 as illustrated in FIGS. 4 and 5, it is assumed that, for example, the first threshold value is set to 800 and the second threshold value is set to 300. However, specific values of the first threshold value and the second threshold value may be arbitrarily set by the designer or a user of the printer 10, or the like.

When a character string is recognized without an error during the recognizing of Act 4, the processor 1 determines ‘Yes’ in Act 5, and performs Act 13 in FIG. 3.

In Act 13, the processor 1 updates history data. The history data indicates a transport speed of the bill when recognition was successful most recently. Thus, the processor 1 updates the history data such that the transport speed set for the immediately previous reading and transporting is indicated.

In Act 14, the processor 1 outputs, from the interface 4 to the host terminal 20, recognition data indicating a result of the recognizing in Act 4.

In Act 15, the processor 1 determines whether a discharge command is received from the host terminal 20. When the discharge command is not received, the processor 1 determines ‘No’ and performs Act 16.

In Act 16, the processor 1 determines whether a print command is received from the host terminal 20. When the print command is not received, the processor 1 determines ‘No’ and returns to Act 15.

As such, the processor 1 stands by for the discharge command or the print command operations Act 15 and Act 16.

The host terminal 20 performs pre-set information processing on the bill when the recognition data output from the interface 4 as described above is received. The information processing is, for example, confirming of validity of the bill. Also, when print data needs to be printed with respect to the bill as a result of the information processing, the host terminal 20 transmits the print command to the printer 10 together with a notification of the print data. When the interface 4 receives the print command, the processor 1 determines ‘Yes’ in Act 16, and performs Act 17.

In Act 17, the processor 1 causes the transport mechanism 5 to start discharging. The discharging is transporting of the bill along the discharge path. The transmit mechanism 5 transports the bill along the discharge path according to control of the processor 1. When the bill is transported to a pre-set discharge position, the transport mechanism 5 ends the discharging. The discharge position is a position where at least a part of the bill is outside the printer 10 from the discharge hole, and is determined, for example, by the designer of the printer 10.

In Act 18, the processor 1 stands by for print start timing. In detail, for example, timing when a region of the bill to be printed by the printer 10 reaches a print position by the thermal head 7 or a print position by the dot impact head 8 is referred to as the print start timing. Also, at the print start timing, the processor 1 determines ‘Yes’ and performs Act 19.

In Act 19, the processor 1 prints the print data notified from the host terminal 20.

Here, the print data may be printed by using the thermal head 7 or by using the dot impact head 8. For example, the dot impact head 8 is used when a transfer type or pressure-sensitive type paper is used as the bill, and the thermal head 7 is used in other cases. Which one of the thermal head 7 and the dot impact head 8 is to be used is determined, for example, based on the print command from the host terminal 20. Alternatively, for example, the printer 10 includes an operation panel and the processor 1 determines which one of the thermal head 7 and the dot impact head 8 is to be used according to an operation on the operation panel. Alternatively, for example, the printer 10 includes a sensor for detecting a type of the bill and the processor 1 determines which one of the thermal head 7 and the dot impact head 8 is to be used, based on a result of the detection by the sensor.

The thermal head 7 and the dot impact head 8 are arranged in a line along the discharge path. Thus, the print position of the thermal head 7 and the print position of the dot impact head 8 are spaced apart from each other. Accordingly, in Act 18, the processor 1 determines the print start timing while considering the difference in the print positions. When the processor 1 performs the information processing based on the information processing programs, the computer including the processor 1 as the central portion operates as a printing unit in cooperation with the thermal head 7 and the dot impact head 8.

Then, the processor 1 performs Act 21.

Meanwhile, when the printing with respect to the bill is not required, for example, when it is determined that the bill is not usable, the host terminal 20 transmits a discharge command to the printer 10. When the interface 4 receives the discharge command, the processor 1 determines ‘Yes’ in Act 15, and performs Act 20.

In Act 20, the processor 1 causes the transport mechanism 5 to start discharging. Then, the processor 1 performs Act 21.

In Act 21, the processor 1 stands by until the discharging is ended. When the transport mechanism 5 ended the discharging, the processor 1 determines ‘Yes’ and ends the information processing illustrated in FIGS. 2 and 3.

Next, details about the speed setting of Act 1 of FIG. 2 will be described.

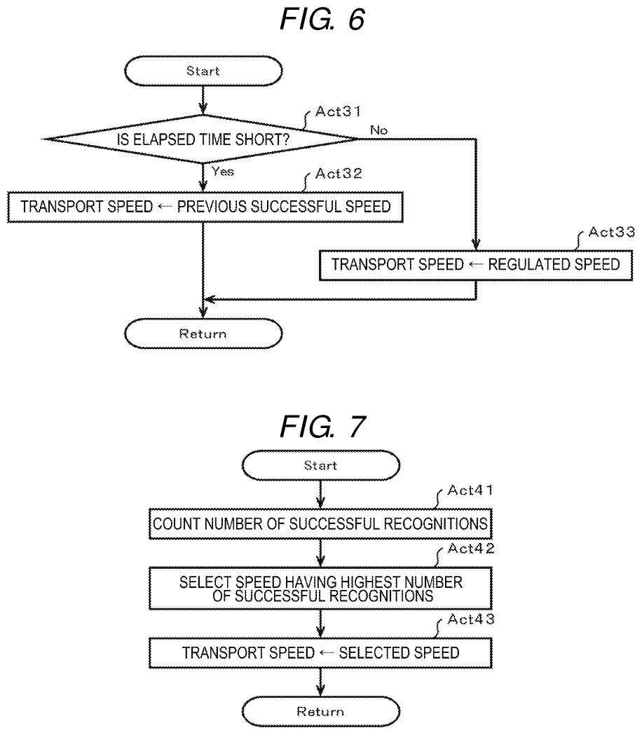

FIG. 6 is a flowchart of a processing procedure of the processor 1 in relation to the speed setting. Here, the speed setting is shown as a subroutine for convenience of description, but the information processing of FIG. 6 may be combined with the information processing of FIGS. 2 and 3 and performed between operations Act 1 and Act 3 of FIG. 2.

In Act 31, the processor 1 determines whether an elapsed time from timing when the recognizing of Act 4 is successful was short during the previous information processing of FIGS. 2 and 3. Here, in general, when the elapsed time was short, it is highly likely that an environmental change was small in a situation where the previous recognition was successful. In other words, the shorter the elapsed time, the higher a possibility that recognition may succeed by transporting the bill at the same transport speed as when the previous recognition was successful. When the elapsed time is shorter than, for example, a pre-set reference time, the processor 1 determines ‘Yes’. In detail, the processor 1 determines ‘Yes’ when, for example, the elapsed time is less than or equal to the reference time or is less than the reference time. When the processor 1 determines ‘Yes’, Act 32 is performed. Here, the reference time may be arbitrarily set by, for example, the designer or user of the printer 10. Also, the elapsed time may be measured by using a software timer or a hardware timer. Alternatively, data indicating a time when the recognition was successful may be included in the history data, and the processor 1 may obtain a time difference between the time indicated by the data and a current time. Here, the software timer may be realized when the processor 1 performs information processing for the software timer separately from the information processing of FIGS. 2, 3, and 6.

In Act 32, the processor 1 sets the transport speed of when the previous recognition was successful as the transport speed for the reading and transporting. In detail, the processor 1 sets the transport speed indicated by the history data as the transport speed for the reading and transporting.

Meanwhile, when the elapsed time is long, it is highly likely that the environmental change was large in the situation where the previous recognition was successful. When an environment is changing, the recognition may not succeed at the same transport speed as when the previous recognition was successful. Thus, when the elapsed time is longer than, for example, the pre-set reference time, the processor 1 determines ‘No’ in Act 31, and performs Act 33.

In Act 33, the processor 1 sets a regulated speed pre-set as an initial setting, as the transport speed for the reading and transporting. The regulated speed is an arbitrary speed, and for example, may be determined by the designer or user of the printer 10. It is assumed that the regulated speed is Speed B. In this case, even when Speed A or Speed C is an appropriate transport speed, the retry number may be restricted to one.

After the transport speed is set in Act 32 or Act 33, the processor 1 ends the speed setting and performs Act 2 of FIG. 2 to perform the above operations.

As such, the processor 1 sets a transport speed for initial recognition with respect to one bill according to a transport speed of when recognition with respect to another bill was successful, via the speed setting. As such, when the processor 1 performs the information processing based on the information processing programs, the computer including the processor 1 as the central portion operates as a setting unit for performing the above settings.

According to the printer 10 described above, a transport speed of when recognition with respect to an immediately preceding bill was successful is set as a transport speed for initial recognition with respect to a new bill. Accordingly, the probability of successful initial recognition may be increased.

However, when Speed A or Speed C is set as the transport speed for the initial recognition but the transport speed for successful recognition was Speed C or Speed A due to a large environmental change or the like, the recognition may not succeed unless the recognition is performed three times. However, the printer 10 refers to the transport speed of when the recognition was successful while setting the transport speed for the initial recognition of the new bill only when the elapsed time after the recognition with respect to the immediately preceding bill was successful is short. In other words, when it is assumed that the environmental change is large due to the long elapsed time, the transport speed of when the previous recognition was successful is not considered. Accordingly, efficiency may be increased by avoiding such situations described above.

The current embodiment may be modified as follows.

The speed setting is not limited as long as a transport speed for initial recognition with respect to one bill is set according to a transport speed of when a recognition unit succeeds in recognizing another bill.

FIG. 7 is a flowchart of a processing procedure of the processor 1 in a modification of the speed setting.

First, when the processing procedure of FIG. 7 is applied as the speed setting, the processor 1 updates the history data to indicate transport speeds of bills when recognitions were successful during a past pre-set period of time, in Act 13 of FIG. 3. The past pre-set period of time may be defined based on time or based on the number of successful recognitions.

In Act 41, the processor 1 counts the number of past successful recognitions per transport speed, based on the history data. For example, the processor 1 may count the number indicated in the history data for each of Speed A, Speed B, and Speed C.

In Act 42, the processor 1 selects, among Speed A, Speed B, and Speed C, one speed having the highest number of successful recognitions. When there are a plurality of speeds having the highest number, the processor 1 selects one speed based on a pre-set priority. The priority may be determined, for example, by the designer or user of the printer 10. The priority may be in a sequential order of Speed B, Speed A, and Speed C. Alternatively, a transport speed of most recent successful recognition may be at the top of the priority.

In Act 43, the processor 1 sets the speed selected as above as the transport speed for the reading and transporting. Then, the processor 1 ends the speed setting and performs Act 2 of FIG. 2 to perform the above operations.

By modifying the speed setting as such, a transport speed having a high probability of successful recognition is set as a transport speed for initial recognition of a newly read bill, according to a tendency of recent successful recognitions during a pre-set period of time. Accordingly, a probability of successful initial recognition may be increased.

Instead of or in addition to the transport mechanism 5, a mechanism for moving the magnetic head 6 may be provided.

The embodiment may be implemented in an apparatus other than a printer, such as an information processing apparatus that has functions of a reading apparatus to process data read from a bill. Alternatively, the embodiment may be implemented in a reading apparatus having only a function of reading a bill.

The reading target is not limited to a bill, such as a check or a promissory note, as long as a character printed on a print medium by using a magnetic ink is read.

The recognizing may be started while the reading and transporting is performed.

The processor 1 may perform. Act 13 when the recognition was not successful despite the recognizing of Act 4 of FIG. 2 is performed a pre-set number of times. In other words, in this case, the processor 1 forcibly discharges the bill determining that the reading is not possible.

Some or all functions provided by the processor 1 via the information processing may be realized by hardware executing information processing not based on a program, such as a logic circuit. Also, each of the functions may be realized by combining software control to hardware, such as a logic circuit.

What is claimed is:

1. A reading apparatus comprising:
a magnetic head outputting a read signal according to a change in a magnetic field;
a moving mechanism moving at least one of the magnetic head and a print medium facing the magnetic head and on which a character is printed with a magnetic ink such that a facing position of the magnetic head with respect to the print medium is changed;
a recognition unit configured to recognize the character based on the read signal output by the magnetic head while the moving mechanism changes the facing position;
a control unit configured to control the moving mechanism and the recognition unit such that, when the recognition unit fails to recognize the character, recognition is performed after a speed of change of the facing position is changed; and
a setting unit configured to set the speed of change for initial recognition with respect to one print medium, according to the speed of change of when the recognition unit succeeds in recognition with respect to another print medium.

2. The apparatus of claim 1, wherein
the setting unit sets, as the speed of change for the initial recognition with respect to the print medium serving as a new reading target, the speed of change of when the recognition unit succeeds in recognition with respect to the print medium that is an immediately preceding reading target of the print medium serving as the new reading target.

3. The apparatus of claim 1, wherein
the setting unit sets, as the speed of change for the initial recognition with respect to the print medium serving as a new reading target, the speed of change of when the recognition unit succeeds in recognition with respect to the print medium that is an immediately preceding reading target of the print medium serving as the new reading target, when an elapsed time after the recognition unit succeeds in recognition with respect to the print medium serving as the immediately preceding reading target is equal to or less than a pre-set reference time.

4. The apparatus of claim 1, wherein
the setting unit sets the speed of change for the initial recognition with respect to the print medium serving as a new reading target, based on a tendency of the speeds of change for multiple recognitions succeeded in past.

5. The apparatus of claim 1, wherein
the control unit determines the speed of change after a change, based on amplitude of the read signal when the recognition unit fails to recognize the character.

6. The apparatus of claim 1, wherein
the print medium is a check.

7. The apparatus of claim 1, wherein
the moving mechanism comprises three speeds of change.

8. A printer comprising:
a magnetic head outputting a read signal according to a change in a magnetic field;
a moving mechanism moving at least one of the magnetic head and a print medium facing the magnetic head and on which a character is printed with a magnetic ink such that a facing position of the magnetic head with respect to the print medium is changed;
a recognition unit configured to recognize the character based on the read signal output by the magnetic head while the moving mechanism changes the facing position;
a control unit configured to control the moving mechanism and the recognition unit such that, when the recognition unit fails to recognize the character, recognition is performed after a speed of change of the facing position is changed;
a setting unit configured to set the speed of change for initial recognition with respect to one print medium, according to the speed of change of when the recognition unit succeeds in recognition with respect to another print medium; and
a printing unit configured to print, on the print medium, information separate from the character.

9. The printer of claim 8, wherein
the setting unit sets, as the speed of change for the initial recognition with respect to the print medium serving as a new reading target, the speed of change of when the recognition unit succeeds in recognition with respect to the print medium that is an immediately preceding reading target of the print medium serving as the new reading target, when an elapsed time after the recognition unit succeeds in recognition with respect to the print medium serving as the immediately preceding reading target is equal to or less than a pre-set reference time.

10. The printer of claim 8, wherein
the setting unit sets the speed of change for the initial recognition with respect to the print medium serving as a new reading target, based on a tendency of the speeds of change for multiple recognitions succeeded in past.

11. The printer of claim 8, wherein
the control unit determines the speed of change after a change, based on amplitude of the read signal when the recognition unit fails to recognize the character.

12. The printer of claim 8, wherein
the print medium is a check.

13. The printer of claim 8, wherein
the moving mechanism comprises three speeds of change.

14. An information processing method of a computer controlling a reading apparatus which comprises a magnetic head outputting a read signal according to a change in a magnetic field and a moving mechanism moving at least one of the magnetic head and a print medium facing the magnetic head and on which a character is printed with a magnetic ink such that a facing position of the magnetic head with respect to the print medium is changed, the method causing the computer to function as:
recognizing the character based on the read signal output by the magnetic head while the moving mechanism changes the facing position;
a control unit configured to control the moving mechanism and the recognition unit such that, when the recognition unit fails to recognize the character, performing recognition after changing a speed of change of the facing position; and
setting the speed of change for initial recognition with respect to one print medium, according to the speed of change of when the recognition unit succeeds in recognition with respect to another print medium.

15. The method of claim 14, further comprising:
setting, as the speed of change for the initial recognition with respect to the print medium serving as a new reading target, the speed of change of when the recognition unit succeeds in recognition with respect to the print medium that is an immediately preceding reading target of the print medium serving as the new reading target.

16. The method of claim 14, further comprising:
setting, as the speed of change for the initial recognition with respect to the print medium serving as a new reading target, the speed of change of when the recognition unit succeeds in recognition with respect to the print medium that is an immediately preceding reading target of the print medium serving as the new reading target, when an elapsed time after the recognition unit succeeds in recognition with respect to the print medium serving as the immediately preceding reading target is equal to or less than a pre-set reference time.

17. The method of claim 14, further comprising:
setting the speed of change for the initial recognition with respect to the print medium serving as a new reading target, based on a tendency of the speeds of change for multiple recognitions succeeded in past.

18. The method of claim 14, further comprising:
determining the speed of change after a change, based on amplitude of the read signal when the recognition unit fails to recognize the character.

19. The method of claim 14, wherein
the print medium is a check.

20. The method of claim 14, wherein
setting the speed of change for initial recognition comprises increasing or decreasing the speed of change.
